(19) United States
(12) Patent Application Publication
(10) Pub. No.: US 2011/0282824 A1
(43) Pub. Date: Nov. 17, 2011

(54) TECHNOLOGIES FOR MAPPING A SET OF CRITERIA

(76) Inventor: Soren Lanng, Skagen (DK)

(21) Appl. No.: 13/145,389

(22) PCT Filed: Feb. 1, 2010
(86) PCT No.: PCT/DK10/00017

§ 371 Date: Jul. 20, 2011

(30) Foreign Application Priority Data
Feb. 3, 2009 (DK) PA200900162

(51) Int. Cl. G06N 5/02

(52) U.S. Cl. 706/52

(57) ABSTRACT

A computerized system with charting capability for development, backtesting and technical analysis of strategies based on criteria used for decision making. The system receives and saves data parameters at different times from external devices. The system uses a method to determine a Probability Indicator from a set of criteria, which may be used to fully map a strategy over time. The method may further be used to visually map a strategy as a graph, which may be regarded as a visual backtest of the strategy. Such graph may be drawn on a chart using the time line of the chart, for the user to compare with the on-chart technical indicators and technical analysis. The Probability Indicator may further be represented as a chart, representing a strategy as a chart, which may be used to perform traditional technical analysis on a strategy. The system further provides a method by which the user, by using a check box, may activate/deactivate a criterion in a strategy updating the Probability Indicator, thereby providing a method for non-programmers to on-the-fly and by a single mouse click, to modify and backtest a strategy with a full map of the strategy. The system further provides a print out of statistical information of the backtest.

### BACKGROUND ART

Strategies for decision making, based on a set of criteria using parameter-data received from one or more external devices, hereinafter called strategies, are used in many areas, such as, in but not limited to; computerized systems controlling and monitoring windmill parks, computerized systems monitoring engine systems, computerized systems for trading a tradable product on stock exchanges. The data used, is typically data streams with parameters, arriving at different times and from different devices, saved in data buffers. Parameters in such data streams are typically, but not limited to; the temperature inside a dynamo of a windmill, the velocity of the dynamo, the ambient wind speed, the temperature at physical spot on an engine, the trading price of a tradable product on a stock exchange, the trading volume of a tradable product on a stock exchange.

The system may typically perform calculations on the data parameters, such as formatting the data to different timeframes, calculate technical indicators, saving the values in data buffers for later use.

The strategy consists of a set of criteria, each criterion having the values true or false. A criterion is typically derived from technical indicators, which are calculated using the parameter data, or derived from technical analysis using the parameter data. A criterion may be but not limited to; day of the week, whether time t is before 14:00, whether time t is summer, whether the slope of a moving average is positive, whether a moving average is above a second moving average, whether a parameter-value is higher than a user defined value.

A classic technical problem in strategies based on a set of criteria is that, no matter the complexity of the strategy, using OR/AND/XOR operators, the strategy will not be efficient, as situations often arise where 9 of 10 criteria are met, but the strategy will not trigger, as the strategy itself is true only if all the active criteria are met. It is in reality not possible or very complex, using traditional backtesting, to construct a strategy which is triggered when a percentage of the criteria are met, as all combinations of the criteria would have to be implemented in the strategy.

Strategies are normally backtested using a set of historical parameter data, producing an output with statistical information such as time stamps of when the strategy trigger, printing this information on the computer monitor or on paper. Using such traditional method of backtesting is a blind test, since the backtest does not fully map the behavior of the strategy, but only the moments where the strategy trigger, printing only the statistics of the these moments. The traditional backtest does not map what happens between the moments where the strategy triggers. In order to fully map a trading strategy using traditional backtesting, thousands of backtests would have to be performed and compared and put together, which is a complex task and in reality not possible or operational. It would be desirable to have a method which fully maps a strategy over time, further to provide a method to visually inspect the full behaviour of the strategy.

FIG. 21 shows an example of a traditional backtest of a set of criteria. For each time value t, each criterion in the set of criteria is verified for the values true or false, if one criterion is false the status of the set of criteria at time t is false and will not trigger. All criteria 77 78 79 have to be true in order to trigger, if all criteria are true, the backtest will trigger and update statistics 80 including updating the list of events with time stamp and related information, and finally print the result, FIG. 13.

During the traditional backtesting, where typically thousands of variants of the strategy have to implemented and backtested, the strategy has to be modified, criteria have to be removed or added, typically by editing the code, recompiling and debugging, which is a slow process. Further, the user operating the computerized system is typically not a programmer, thus the strategy is typically fixed and cannot be modified by the operator. Further, it is not possible to modify or adjust the strategy on-the-fly during live operation, due to the long and time consuming process of backtesting the strategy. It would be desirable to have a method which the user can use to edit and backtest a strategy on-the-fly, using single mouse click operation, without the need of programming, compiling or debugging.

When adding a new criterion to the pool of available criteria in the system, the full behaviour of this criterion is unknown till the criterion has been used in a number of backtests and strategies. A new criterion may be backtested using this criterion only in order to test whether the criterion behaves as anticipated, but this backtest is a blind test, since the behaviour of the criterion is not fully mapped.

The computerized system may be used by an operator for manually sending commands to a number of external devices, or the computerized system may use the decision to automatically send commands to a number of external devices.

### DISCLOSURE OF INVENTION

The present invention solves a range of technical problems within the construction, backtesting and technical analysis of strategies based on a set of criteria, using data parameters received from one or more external devices.

A technology to create a data buffer holding a determined value for each time value t of a set of criteria, hereinafter referred to a Probability Indicator, providing a result which fully maps a strategy over time. The Probability Indicator is determined by comparing each active criterion in the set of criteria with saved parameter data at each time value t, using the result to determine the value of the Probability Indicator at each time value t.

Providing a technology to perform a visual backtest of the set of criteria, by representing the determined data buffer as a graph, providing a novel result, where the user can inspect the full behaviour of a strategy at a glance, solving the problem of blind testing.

Providing a technology to perform a visual backtest of the set of criteria, by representing the determined data buffer as a chart, hereinafter called a PROB Chart, thereby showing a strategy as a chart, thereby making it possible to perform traditional technical analysis on a strategy, providing novel results.

The invention may further be adapted to use a selector to include/remove a criterion in the set of criteria, where the system is adapted to, each time a selector is activated/deactivated, to for each time value collect the state of each criterion active in the strategy, save those values in a data buffer, determine and update the Probability Indicator and the PROB chart. Providing on-the-fly operation without programming or compilation, providing strategy development with backtesting to non-programmers, which may speed up the development and compilation time by a factor of 100 to 1000. The user may test thousands of variants in less than a an hour, which using traditional methods would take days or even weeks. Such selector may be, but not limited to; a check box, an icon, a button, panels, a grid-cell. Such selector is hereinafter called a check box.

An example of such Probability Indicator, using non-weighted criteria values is; in case 8 of 10 active criteria are met at a specific time value, the value of the Probability Indicator is 80% at this specific time value.

Traditionally a technical analysis is based on one data stream, visualized on a corresponding chart. By using a set of criteria instead of data from a single data stream, the Probability Indicator is chart-independent, since a criterion can be based on any type of data, providing a technology to backtest and fully map a strategy across technical as well as across fundamental data, across data streams and across external devices.

Melting together the technical analysis and the strategy is a natural step, and a wanted step. Since a technical analysis is made within minutes, or even seconds, and traditionally the process of developing a strategy including backtesting is a matter of days or even months, it has not been possible to melt those two together. Further, the operator using technical analysis is typically not a programmer. This is now possible by the present invention, using a Probability Indicator combined with use of check boxes to dynamically add/remove criteria from the set of criteria, providing instant results with a full map of the strategy, moving the use of strategies to the operator for on-the-fly technical analysis using strategies based on a set of criteria.

### BRIEF DESCRIPTION OF DRAWINGS

FIG. 1 is a block diagram showing an example of at computerized system of the present invention;

FIG. 2 is an example of types of data streams and parameter-values;

FIG. 3 is an example of a flow chart showing the basic flow of new data arriving at time t;

FIG. 4. is an example of a flow chart showing how the value of a Probability Indicator at time t may be determined;

FIG. 5 is an example of a flow chart showing an example of the flow when a check box changes state updating the Probability Indicator;

FIG. 6 is an example of check boxes related to the criteria in a strategy;

FIG. 7 an example of a flow chart showing how the value of a positive-side Probability Indicator at time t may be determined;

FIG. 8 an example of a flow chart showing how the value of a negative-side Probability Indicator at time t may be determined;

FIG. 9 is an example of a flow chart showing an example of the flow when a check box changes state updating both the positive- and negative-side the Probability Indicator;

FIG. 10 is an example showing both a positive- and a negative-side graph of Probability Indicators;

FIG. 11 is an example of a flow chart showing an example of the flow of a Decision Manager for a positive-side Probability Indicator;

FIG. 12 is an example of a flow chart showing an example of the flow of a Decision Manager for a negative-side Probability Indicator;

FIG. 13 is an example of print out of a backtest;

FIG. 14 is an example of check boxes related to criteria, placed on a chart.

FIG. 15 is an example of a chart with a Probability Indicator, and the related PROB chart;

FIG. 16 is an example of performing a visual test of a new criterion;

FIG. 17 is an example of a flow chart showing an example of the flow of constructing a bar chart from a probability Indicator;

FIG. 18 is an example of a flow chart showing an example of the flow of changing the relation of a check box to a new criterion.

FIG. 19 is an example of a Criterion Manager for selecting the criterion to be related to a check box.

FIG. 20 is an example of how a method for setting the level of a Probability Indicator for triggering an event, and showing examples of further criteria which may be selected;

FIG. 21 is an example of a flow chart showing a traditional backtest of a set of criteria.

FIG. 22 is an example of a flow chart showing an example of a performing a backtest of a strategy, using a user defined level, printing the statistical results.

### MODE(S) FOR CARRYING OUT THE INVENTION

The present invention concerns a computerized system 1 used for developing, backtesting and analyzing a set of criteria for decision making, solving a range of technical problems. Most computerized systems for decision making have bar charting capability, which are used to visualize the parameter-data over time.

The efficiency and the usability of the set of criteria selected, depends on the skills of the user, as the set of criteria is typically defined by the user himself, the user defines/selects the set of criteria which forms the strategy. Since the criteria used in the strategy are defined by the user, and the value of Probability Indicator at time t is based on these criteria, the resulting Probability Indicator is the result of the user defining/selecting a set of criteria.

The criteria used in a strategy may be based on parameter data from, but not limited to; different timeframes, different devices, different symbols on stock exchanges, fundamental data at stock exchanges, time and day data, technical analysis, technical indicators.

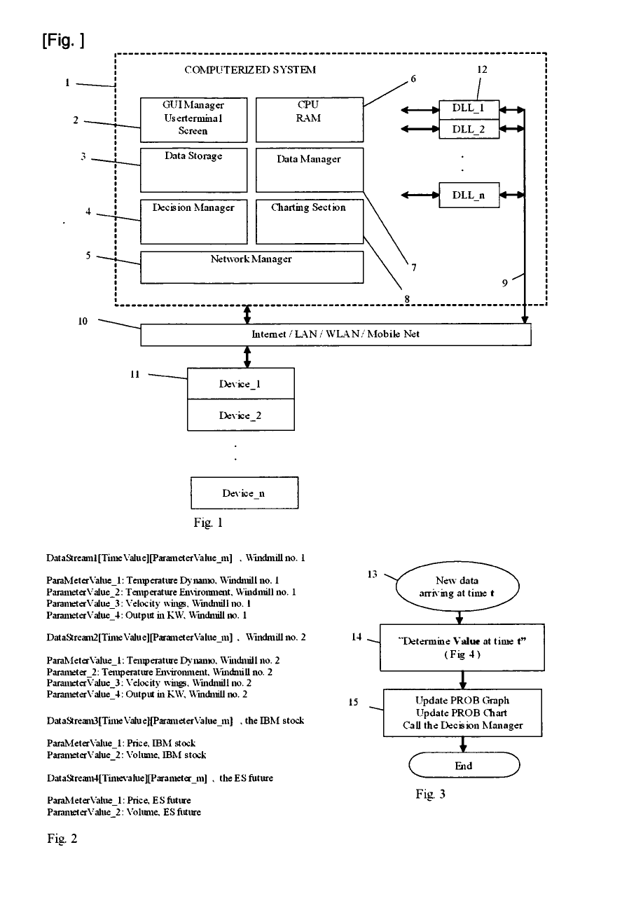

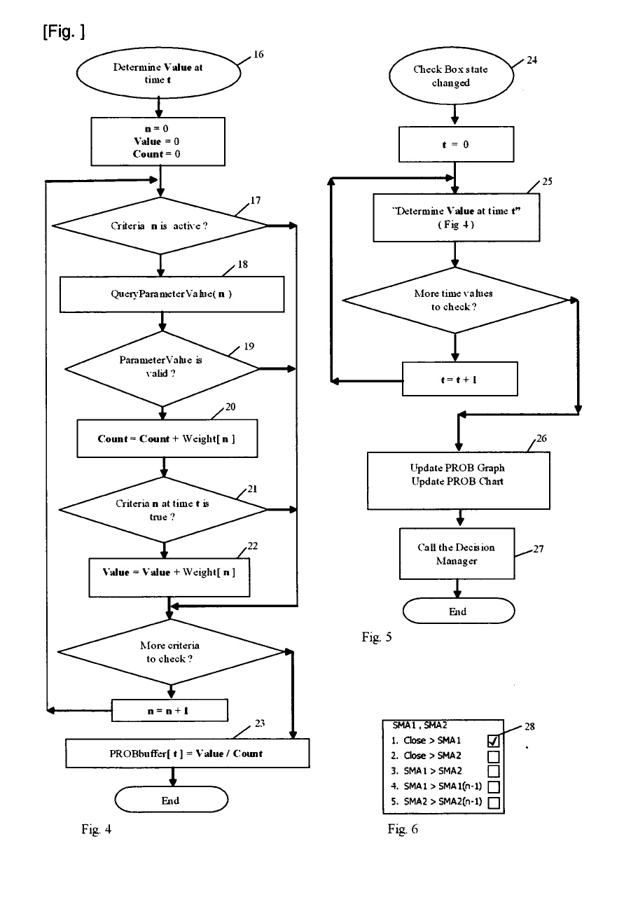

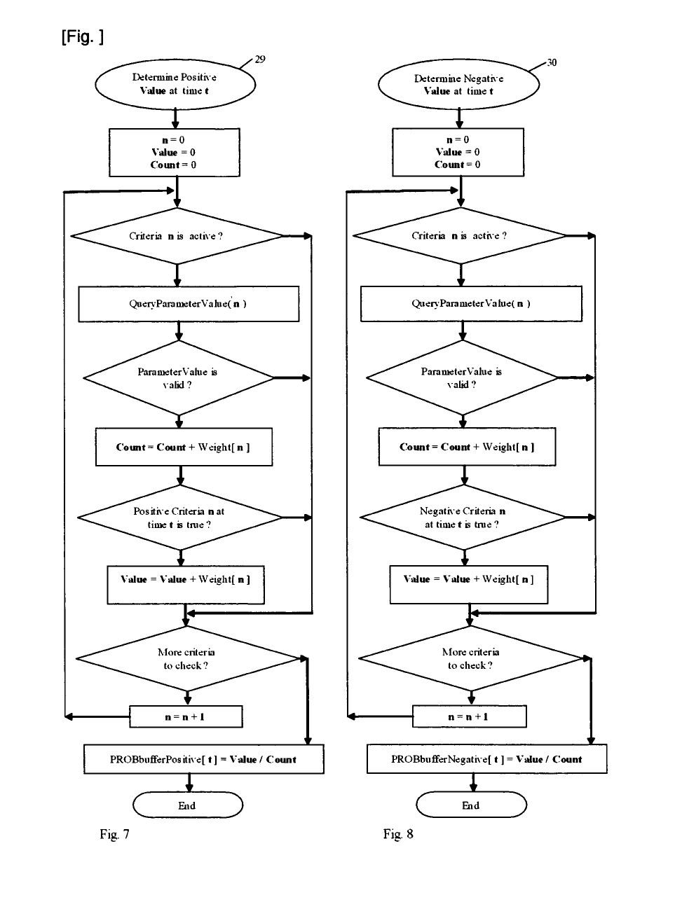

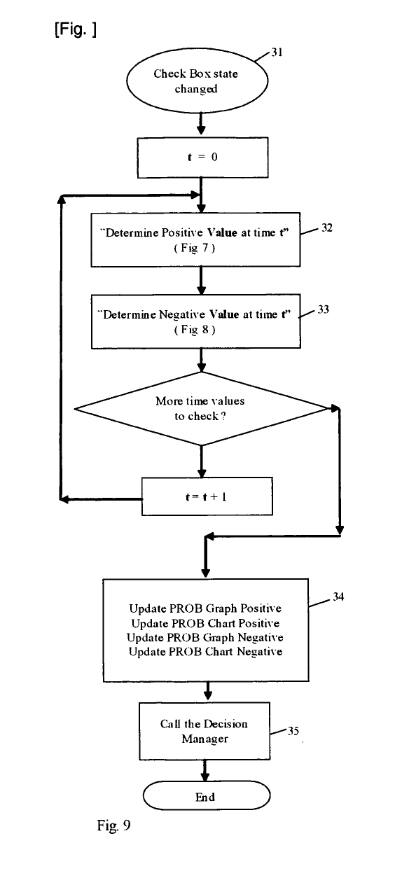

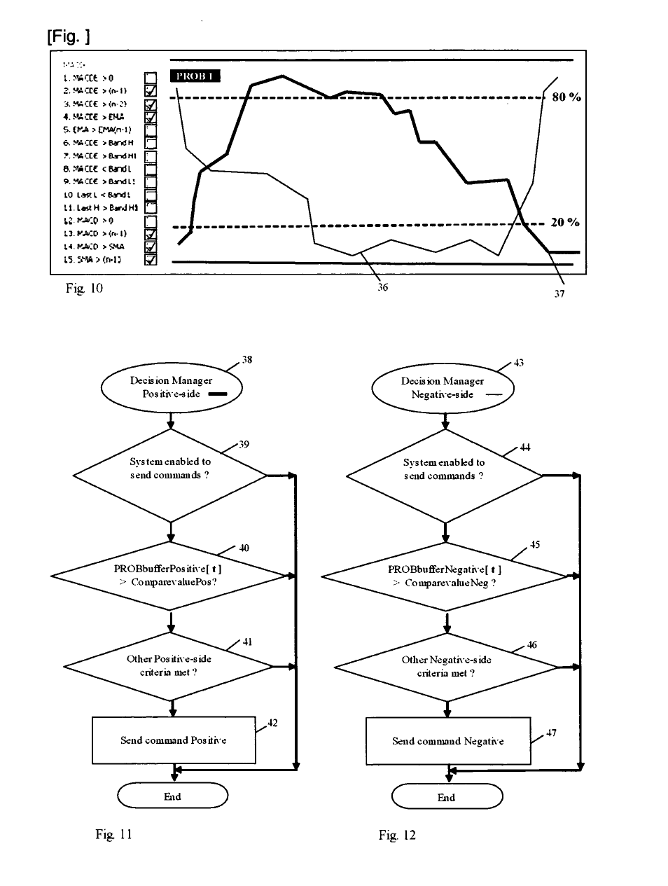

FIG. 1 is a block diagram showing an example of a computerized system 1, having a user terminal 2 connected to a GUI, using a network 10. Such computerized system may be, but not limited to; a desk top computer, a portable computer, a mobile phone, as server. The system may be connected to external sources and devices 11 12, from which the system may receive data streams with parameter data at different times t, saving the data streams in a data storage on the computerized system 3 or on a remote data storage 12. Such device may be, but not limited to; servers, clients, data bases, mobile phones, modems, network-routers, other computers, user terminals. A data stream may contain parameter-values from an external device such as but not limited to; temperature values, velocities, amount values, prices, gains, volumes. FIG. 2 shows an example of such data streams.

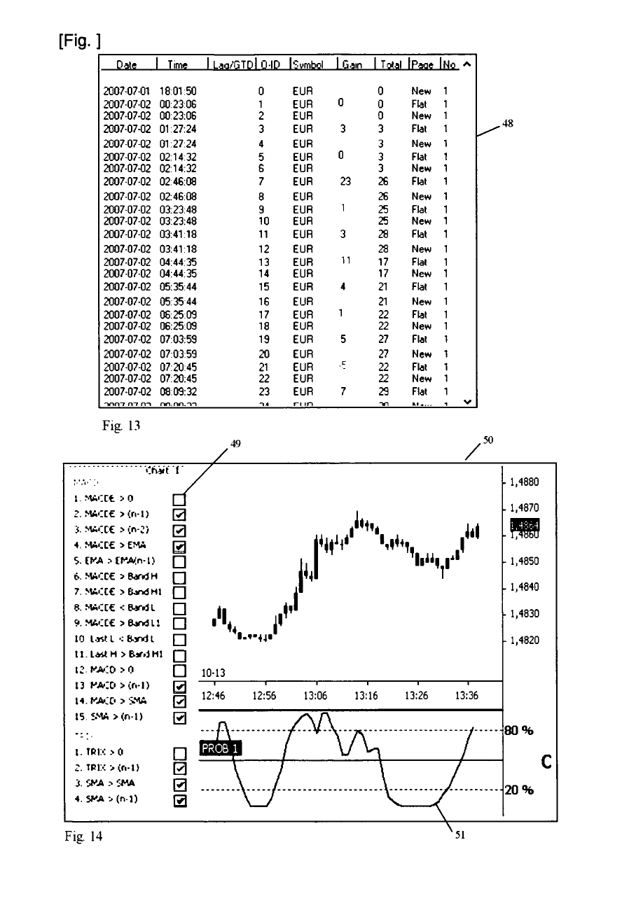

The computerized system may calculate technical indicators such as, but not limited to; Simple Moving Average, MACD, RSI, CCI, Bollinger, Trix, and save those values in a data buffer at time t for later use by the strategy, the criteria and the determination of the Probability Indicator. Each moment new data is received at time t, a Data Manager 7 may start a method shown as the flow chart in FIG. 3, updating 14 the value of the PROBbuffer at time t, and may further update related graphs and charts 15. The flow chart in FIG. 4 shows in detail how the value of the Probability Indicator may be determined, the system may check each criterion whether the criterion is active in the strategy 17, if the criterion is not active, the criterion may be ignored. The parameter-data used for the criterion may already be available in a data buffer, or the system may need to query 18 the parameter value for the time t from a data source such as, but limited to; a data buffer, a data base on the computerized system, a data base on a remote system, or may query the parameter-value directly from the external device as a pull event 18. The parameter-value may be verified for valid content, 19. On each active and valid criterion, a counter may be updated with a user defined value 20, which may be a fixed value for all criteria, or may be a weighted value for each individual criterion, fetched from a data buffer. The process may check each active criterion for the values true or false 21, using and comparing against data such as, but limited to; parameter values, a fixed user defined value, a value derived from a technical indicator such as a Moving Average. The comparison with stored data may be performed by using a method such as, but not limited to; a chunk of compiled code; a script written in a scripting language, a chunk of code in a DLL file 12. In case using a DLL for checking a criterion, such DLL may query/receive parameter-values from external devices 9. A fixed value may be the number “one”, a parameter-value may be the parameter-value at time t−1. In case the criterion is true, a buffer-value “Value” may be updated with a user defined value 22, which may be a fixed value for all criteria, or may be a weighted value for each individual criterion, fetched from a data buffer. When all criteria have been checked, the value of the Probability Indicator at time t 23 may be determined. This value at time t may be determined by a division Value/Count. This determined value may be saved in the buffer as; PROBbuffer[t]=determined value.

The computerized system may be adapted to perform a full update of the PROBbuffer, shown in the flow chart FIG. 5. Such update may be useful when the data in one or more data buffers changes. The value of the buffer at time t may be updated, by looping through all the records in the buffer, updating the PROBbuffer 25 holding the data representing the Probability Indicator.

The system may be keep all received parameter values, and keep all saved values from the calculation of the technical indicators for each time t, providing the possibility to on-the-fly update the values of the Probability Indicator for each time t. This is useful when the operator adds or removes a criterion from the strategy, or change the active status of a criterion, or when the operator changes the parameter value for one or more criteria.

The PROBbuffer may be visualized as a graph 36 37 51 52 57, visualizing the behaviour of the set of criteria over time, fully mapping the strategy instead of the blind testing used in traditional backtesting. An example of print-out from a traditional backtest is shown in FIG. 13. The graph representing the PROBbuffer may be drawn on a chart 50 51. By drawing the PROBbuffer on a chart, the behavior of the strategy may be compared with technical analysis or other data sets drawn on the chart. An example is shown on FIG. 16, where the Probability Indicator may be compared with the MACD technical indicator 56.

A new criterion added to the system may be tested by using a Probability Indicator, providing a full map of the behaviour of the new criterion, FIG. 14, 57 58.

The system may use a technology, a check box, where the user have the possibility to change the active-status of a criterion, setting a criterion active or inactive by a single mouse click FIG. 14, 49. The event of setting a criterion inactive is regarded as a removal of the criterion from the strategy. Each criterion used in the system may have a related check box. FIG. 5 shows a flowchart of how such technology may be implemented. When a check box changes status 24 49, by the user clicking the check box 49, the system may update the PROBbuffer 25, and may update the related PROB graph and PROB chart 26, and finally may call a Decision Manager 27.

Used together with the instant update and update of the PROBbuffer, this method provides the operator with a method to on-the-fly modify and inspect the strategy as a graph by a single mouse click.

The check box 49 may be placed directly on a chart 50, or may be placed on a separate window. Since the operator may select criteria from a large number of criteria, it may not be operational to place a check box on the chart/window for each criterion available, it may be desirable to have a limited number of check boxes on the chart/windows at a time. A check box may dynamically be dedicated to a criterion by the user. FIG. 8 shows a flow chart of how the operator may define and change the related criterion to a check box. The operator may open a Criteria Manager FIG. 19 to select the criterion from the pool of available criteria 70, relating the selected criterion to the specific check box. A check box may dynamically be added or/and removed, a chunk of compiled code or a script, containing one or more criteria, may dynamically be added and removed from the pool of available criteria. A DLL may dynamically be added and removed, adding and removing one or more criteria from the pool of available criteria.

Strategies may be divided in positive-side strategies and negative-side strategies. Most technical indicators are typically a “graph” either having a positive or a negative slope, or a zero-slope. Such graph may be the Moving Average of a temperature, if the temperature is rising and the strategy is used for monitoring the temperature of an external device, taking action if the temperature exceeds a value, such trading strategy may be categorized as a positive-side strategy. Taking action if the temperature is below a value, such trading strategy may be categorized as a negative-side strategy.

Since there are strategies which may use both the positive slopes and the negative slopes, the two mentioned types of Probability Indicators may be needed in the computerized system. A decision making strategy for when to stop a windmill and when to restart a windmill may require two different strategies, one for stopping the windmill if the wind velocity is too high in the area, and one for restarting the windmill when the wind speed is below the limit and stable. For using strategies on tradable products on stock exchanges, a positive-strategy may be used for the buy-side, when technical indicators have a positive slope, and a negative-strategy may be used for the sell-side. FIG. 7 shows a flow chart updating the PROBbufferPositive, using the positive-side of the criteria. FIG. 8 shows a flow chart updating the PROBbufferNegative. FIG. 10 shows an example of a two graphs representing the two buffers. The bold line 37 is representing the positive-side Probability Indicator, using the PRObufferPositive buffer. The thin line 36 is representing the negative-side Probability Indicator, using the PROBbufferNegative buffer.

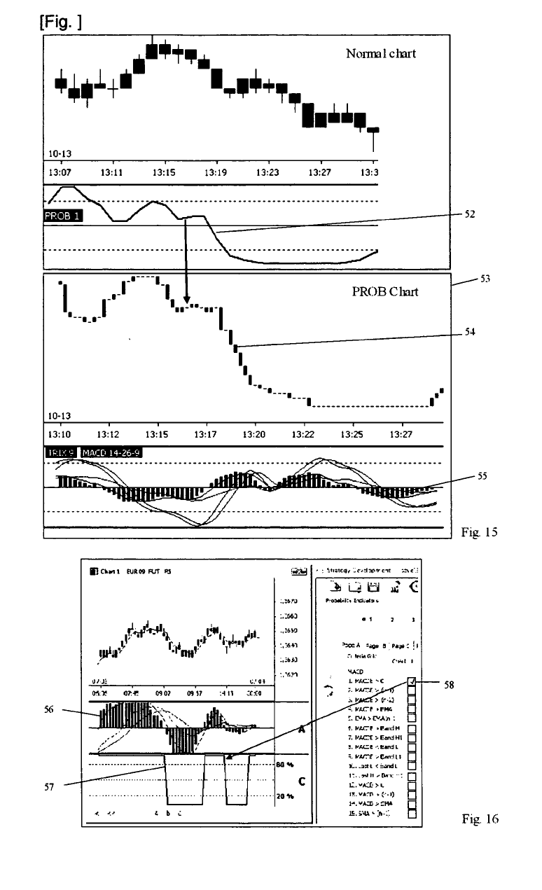

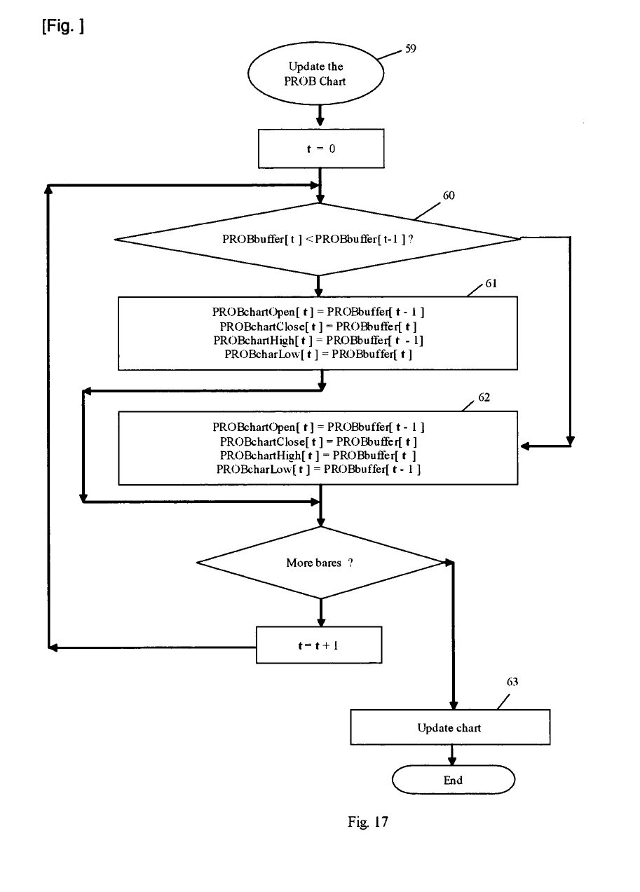

The PROBbuffer may be visually presented as a chart FIG. 15, 53 54, mapping the strategy as a chart. By representing the Probability Indicator as a chart, traditional technical analysis, such as MACD 55, may be performed on the strategy itself, by using the technical analysis and technical indicators typically available for charts. The Probability Indicator may be shown as candle stick bars 54. FIG. 17 shows an example of how the bars may be constructed using the Probability Indicator. The color of the bar, up-bar or down-bar, is determined in 60, the high, low, open and close values are determined and saved in a data buffer for each time t, 61 62, by using the value of the Probability Indicator at time t and at time t−1. Finally the chart me be updated 63 with the new chart PROBchart buffer 63. In case the Probability Indicator is using mirrored presentation, the PROB Chart may be selected for either the positive-side or the negative-side buffer.

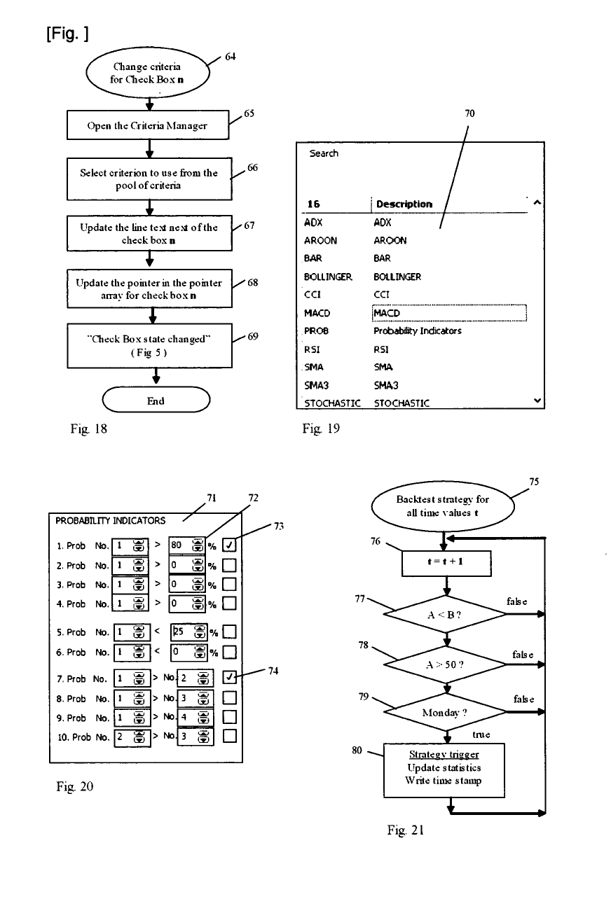

The system may use a method to set a level of the Probability Indicator where the strategy will trigger, sending a command to users such as, but not limited to; the user, to a Decision Manager, to an external device. FIG. 20, 72 shows an example of a method to set such level. The computerized system may be designed to use further criteria which have to be met before a command is send. FIG. 18 shows an example of a flow chart of such method.

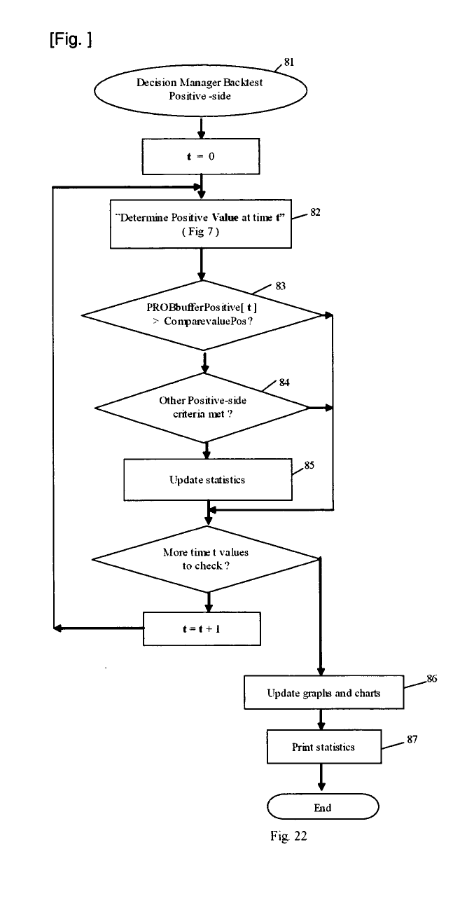

The system may use a method to make a print out of the resulting statistics each time the PROBbuffers are updated, providing a one-click on-the-fly backtest with a traditional print-out of the results as shown in FIG. 13. FIG. 21 is a flow chart showing an example of how such may be implemented using a positive-side Probability Indicator. For each time t, the value of the PROBbufferPositive is determined 82, in case a level has been set, the value of the PROBbufferPositive is checked against a user defined level ComparevaluePos 83, further if used, additional positive-side criteria may be checked for true/false. In case both 83 and 84 are met, the statistics may be updated 85. When all time values have been looped, the system may update the PROB graphs and the PROB charts 86, and may print the final statistics the traditional way 87, FIG. 13.

### Example

### The Status of an Engine

Engines are typically monitored by a number of temperature censors placed on different locations on or nearby the engine. The monitoring system is typically a decision making system, alerting the user, stopping the engine, blinking a lamp or taking similar actions. The temperatures measured at each censor, gives a joint picture of the status of the engine. It may not be critical if 1 of 10 censors indicates a temperature rise, but in case 8 of the 10 censor indicates a temperature rise, there may be a reason to trigger a warning or an action. Performing a backtest using the traditional method may provide a print out of only a few moments where the engine overheats, but may be unaware that 8 of 10 censors are indicating overheating a majority of the time. Using the invention to perform a full map of the strategy over time may discover such system hazards.

### Example

### The Status of a Windmill

Similar to the engine example, a windmill may send data of different parameters to a decision making system for analysis and decision making of when to stop the mill, and when to restart the mill. Such parameters may be temperatures, velocities, kW producing, temperatures measured on a number of locations inside the windmill. In case of a windmill park, the value-parameters may be collected from a number of mills in the park, which the system may use for the decision of the optimal angle of the blades. If the wind speed is exceeding a warning value at 8 of 10 locations, the system may decide to send a global warning to all the windmills, also the windmills with wind speed below the warning level. The computerized monitoring systems monitoring windmills and parks, uses typically charting facilities to visually present the status of each parameter such as the wind speed, the output generated etc.

### Example

### The Status of a Price of a Tradable Product on Stock Exchanges

Traditionally technical analysis uses single chart data, and is chart dependent. Using data from several timeframes, from different symbols or markets, or even using fundamental data may add valuable information to a strategy. Using criteria rather than data, representing a strategy as a graph or as a chart, provides a chart-independent method to develop and backtest strategies. The strategy may be visually mapped on any chart in the system.

### Example

### Mapping a Risk Over Time

Probability Indicators may be used to determine the risk at a specific time value by using criteria using data from different data types and nature. The risk over time may be mapped visually, and the user may use a set of check boxes, one for each selectable criterion, to construct a risk profile which over time in average provides the lowest risk. The Probability Indicator may also be used to map the risk of a on-going situation.

### Sequence Listing Free Text

This application is a PCT application based upon Denmark Application No. PA2009 00162 filed on Feb. 3, 2009.

1. A computerized system for technical analysis and strategy development having charting capability, comprising a user terminal connected to a data communication system, said computerized system being adapted to provide a graphical user interface (GUI); said system being adapted to use at least one network connection sending data to and receiving data from at least one external device; said system being adapted to receive at least one data stream with parameter data arriving at different times from at least one external device, saving said data stream in a data buffer; said system having at least one set of criteria each having at least two criteria which are used to form a strategy for decision making, or which are used for technical analysis using at least one chart; said system being adapted to determine the value true/false of each criterion at every time-value of the data parameters stored; said system being adapted to, for each time value, to determine the value of at least one Probability Indicator, by using the status-value true/false of each active criterion in the set of criteria at said time value, saving said values in a data buffer, mapping the set of active criteria over time;

2. The computerized system according to claim 1, being adapted to; for each time value of the stored data parameters, to determine the value true/false of each criterion in the set of criteria; for each active criterion, to add a user defined value to a count-value; for each true and active criterion, to add a user defined value to a sum-value; finally divide this sum-value with the count-value, and save the result in a data buffer for the specific time value.

3. The computerized system according to claim 2, wherein the result stored in the data buffer in claim 2 represents the probability value of the set of active criteria at the specific time value.

4. The computerized system according to claim 3, wherein the set of results stored in the data buffer forms a Probability Indicator mapping the strategy over time.

5. The computerized system according to claim 4, wherein at least two criteria in the set of criteria are using parameters from different timeframes.

6. The computerized system according to claim 4, wherein at least two criteria in the set of criteria are using parameters from different symbols or devices.

7. The computerized system according to claim 4, being adapted to; provide a positive-side Probability Indicator using the active positive-side criteria for the determination of the said positive-side Probability Indicator; provide a negative-side Probability Indicator using the active negative-side criteria for the determination of the said negative-side Probability Indicator.

8. The computerized system according to the claim 4, wherein the data buffer holding the Probability Indicator is represented as a graph, mapping the set of criteria on a graph.

9. The computerized system according to claim 4, wherein the data buffer holding the Probability Indicator is represented as a bar chart, mapping the set of criteria as a bar chart.

10. The computerized system according to claim 4, wherein the Probability Indicator is used in a decision method, using a level of probability where the computerized system is adapted to send a command to an external device.

11. The computerized system according to claim 4, said computerized system being adapted to provide a selector for each selectable criterion, setting the related criterion active or inactive in the strategy; wherein said selector is represented among the selector types; check box, button, icon, panel, grid-cell; wherein the system is adapted to update the values of the Probability Indicator when a selector related to a criterion changes status, verifying each criterion for the status true or false at every time value of the data parameters stored, using and checking only the criteria set active, updating the data buffer holding the values of the Probability Indicator, updating the related PROB graph and the PROB chart.

12. The computerized system according to claim 11, wherein the user can dynamically add and remove the mentioned selectors.

13. The computerized system according to claim 11, wherein the selectors are positioned on a chart.

14. The computerized system according to claim 11, wherein the relation of a criterion to a specific selector is defined dynamically, by selecting the criterion to use for said selector from a pool of available criteria.

15. The computerized system according to claim 11, being adapted to use at least one DLL which checks at least one criterion in a strategy for the status true/false.

16. The computerized system according to claim 11, being adapted to use at least one script which checks at least one criterion in a strategy for the status true/false.

17. The computerized system according to claim 11, wherein a criterion, in the form of compiled code or in the form of a script, dynamically can be added or removed to/from the pool of available criteria.
